(19) United States
(12) Patent Application Publication
(10) Pub. No.: US 2025/0181289 A1
(43) Pub. Date: Jun. 5, 2025

(54) IMAGE FORMING APPARATUS

(71) Applicant: Toshiba Tec Kabushiki Kaisha, Tokyo (JP)

(72) Inventor: Hiroyuki KATO, Mishima Shizuoka (JP)

(21) Appl. No.: 18/743,753

(22) Filed: Jun. 14, 2024

(30) Foreign Application Priority Data
Dec. 5, 2023 (JP) 2023-205290

(51) Int. Cl. G06F 3/12; H04N 1/00

(52) U.S. Cl. CPC G06F 3/1243; G06F 3/1208; G06F 3/1256; H04N 1/00411; H04N 1/00427; H04N 1/0044

(57) ABSTRACT

According to an embodiment, an image forming apparatus includes a printer to print images, a display screen, and an operation panel for permitting the operator to select an image template for printing. The image template includes a fixed data region and a variable data region. The apparatus has a processor and an external interface that is connected to an external input device to receive input data to be included in the variable data region. The processor generates a preview image corresponding to the selected image template with the received input data included in the variable data region, stores the preview image in a storage location accessible by an external device, generates a code image indicating the storage location, and displays the code image on the display screen upon a request of the operator to permit the operator to confirm the preview image using the external device.

### CROSS-REFERENCE TO RELATED APPLICATION

This application is based upon and claims the benefit of priority from Japanese Patent Application No. 2023-205290, filed Dec. 5, 2023, the entire contents of which are incorporated herein by reference.

### FIELD

Embodiments described herein relate generally to an image forming apparatus such as a barcode printer, a label printer, or the like.

### BACKGROUND

A barcode printer is an image forming apparatus that prints a label to be attached to or included on a product package or the like. A barcode printer can also have a function called stand-alone printing for printing other images on a label in addition to a barcode or the like. The stand-alone printing process can generate print data for the label printing by combining variable data received from various input devices, such as a code reader and/or a keyboard, with other fixed (non-variable) data.

However, it is often difficult to provide a display device in the barcode printer having a large display screen size due to limitations such as the cost and the normal printer housing size. It may be difficult for the barcode printer to incorporate a fully useful display device with a touch panel or the like due to the associated costs. Therefore, the barcode printers in the related art have a problem in that it is difficult to perform a detailed pre-printing check of a label image generated for stand-alone printing on the provided display device of the barcode printer.

### BRIEF DESCRIPTION OF THE DRAWINGS

FIG. 1 is a diagram schematically showing a printing system including a barcode printer according to an embodiment.

FIG. 2 is a perspective view of a barcode printer.

FIG. 3 is a diagram showing an example of a label data format before a barcode printer combines variable data with fixed data.

FIG. 4 is a diagram showing an image printed by a barcode printer based on label data.

FIG. 5 is a diagram showing an example of label data after a barcode printer combines variable data with fixed data.

FIG. 6 is a diagram showing a print image printed by a barcode printer based on label data.

FIG. 7 is a diagram of a data reading (input) screen displayed on a display unit.

FIG. 8 is a diagram of a data reading result screen.

FIG. 9 is a diagram of a preview link screen.

FIG. 10 depicts an example in which a smart device of a printing system displays a preview image.

FIG. 11 is a sequence diagram of an operation example of a printing system.

FIG. 12 is a flowchart of an operation example of a barcode printer.

### DETAILED DESCRIPTION

In general, according to one embodiment, an image forming apparatus is described that allows a printed image to be checked in detail before printing.

According to the embodiment, an image forming apparatus includes a printer unit configured to print images, a display screen for displaying information to an operator, and an operation panel for permitting the operator to select an image template for printing. The image template includes a fixed data region and a variable data region. The apparatus also has an external interface to connect to an external input device to receive input data to be included in the variable data region of a selected image template. A processor of the apparatus is configured to generate a preview image of an image to be printed by the printer unit, the preview image corresponding to the selected image template with the received input data included in the variable data region, store the preview image in a storage location accessible by an external device, generate a code image indicating the storage location, and display the code image on the display screen upon a request of the operator.

Hereinafter, an example embodiment will be described with reference to the drawings.

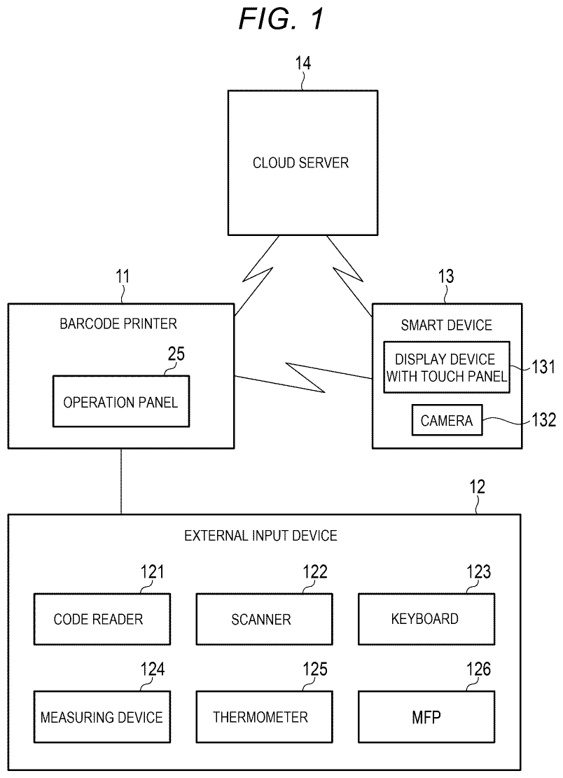

FIG. 1 is a diagram showing the configuration example of a printing system including a barcode printer 11 according to an embodiment. The barcode printer 11 may also be referred to as a label printer or the like.

The barcode printer 11 according to the embodiment is an image forming apparatus that prints an image to be used as a label. The label can be printed on a medium such as label paper or label stock. The barcode printer 11 has a stand-alone printing function for generating print data (hereinafter also referred to as label data) for an image to be printed on a label by the barcode printer 11 itself. The generated print data is then printed onto a medium according to an instruction of an operator (user).

As shown in FIG. 1, the barcode printer 11 has an interface connected to an external input device 12. Examples of an external input device 12 include a code reader 121, a scanner 122, a keyboard 123, a measuring device 124, a thermometer 125, and a digital multi-functional peripheral (MFP) 126.

The code reader 121 is a device that reads a code image such as a barcode or other two-dimensional code. The scanner 122 is a device that reads an image. The keyboard 123 is a device for the operator to input text information. The measuring device 124 is a device that measures the weight of a product to be labeled or the like. The thermometer 125 is a device that measures a relevant temperature. The digital multi-functional peripheral (MFP) 126 is a device including a scanner or the like.

The barcode printer 11 acquires, from one or more external input devices 12, information such as text information, a symbol image, a barcode, and the like to be printed on the label in the stand-alone printing. The barcode printer 11 generates label data by setting various types of information acquired from the external input device(s) 12 at a predetermined position within provided fixed data (e.g., a label format or shell label). The barcode printer 11 generates a label by printing an image based on the generated label data on a label medium.

The barcode printer 11 has an interface for communicating with a smart device 13.

The smart device 13 is, for example, an external information processing device such as a smartphone or a tablet PC. The smart device 13 generally includes a display screen, an input operation unit, an image capturing unit, and the like in addition to a processor and a communication interface. For example, in the configuration example shown in FIG. 1, the smart device 13 includes a display device 131 with a touch panel and a camera 132 as components.

The smart device 13 includes a processor, such as a CPU, and memory. The smart device 13 executes various types of processing by the processor executing a program stored in the memory. For example, the smart device 13 executes processing such as reading a two-dimensional code and displaying a preview image (PNG) associated with the two-dimensional code when the processor executes a program stored in the memory.

The communication interface of the smart device 13 is, for example, a communication interface that executes wireless communication. The smart device 13 communicates with a device connected to a network such as the Internet via the communication interface.

The display screen and the operation unit of the smart device 13 are implemented as, for example, the display device 131 with a touch panel. The smart device 13 may include a hard key (buttons or the like) provided on a housing of the smart device 13.

The camera 132 of the smart device 13 is used as an image capturing unit to capture an image of a two-dimensional code for a process to be described later. In this case, smart device 13 operates as a two-dimensional code reader that can read a two-dimensional code by using the camera 132.

The barcode printer 11 stores data for a preview image in a location (a storage destination) that can be accessed by the smart device 13. The barcode printer 11 provides information (for example, a URL or other access information) for accessing the preview image to the smart device 13. The barcode printer 11 includes an operation panel 25 including a display unit and an operation unit. The barcode printer 11 has a function of providing a preview image to the smart device 13 by providing access information for the preview image to be displayed on smart device 13. The barcode printer 11 provides the necessary access information (e.g., a link or the like) on the display unit of its operation panel 25.

For example, the barcode printer 11 displays the access information as a two-dimensional code on the operation panel 25. The smart device 13 acquires the access information by reading and decoding the two-dimensional code displayed on the operation panel 25. The smart device 13 can then acquire the preview image from a location indicated by the access information and display the acquired preview image on the display device 131.

In some examples, barcode printer 11 may have an interface for communicating with a cloud server 14 (or an external server).

The cloud server 14 is capable of communicating with the smart device 13 via a network such as the Internet. For example, the cloud server 14 provides a website for display of the preview image on the smart device 13. In this case, the barcode printer 11 transfers the preview image to the cloud server 14, and stores the preview image to be displayed on the smart device 13 in the cloud server 14. When the preview image is stored in the cloud server 14, the barcode printer 11 identifies the access information indicating the storage destination of the preview image in the cloud server 14. The barcode printer 11 provides the access information indicating the storage destination (the access destination) of the preview image to the smart device 13 in the form of a code image or the like.

The cloud server 14 provides the preview image to the accessed smart device 13 according to the access information provided by the barcode printer 11. The cloud server 14 may accept a correction to an image (label data) on the website in response to an instruction from the smart device 13 for the preview image. The cloud server 14 may supply, to the barcode printer 11, correction data (or corrected label data) for label data indicating the content of correction(s) to the preview image. In this case, the barcode printer 11 may correct the label data according to the correction data for the label data from the cloud server 14.

Next, the configuration of the barcode printer 11 in a label printing system 1 according to the embodiment will be described.

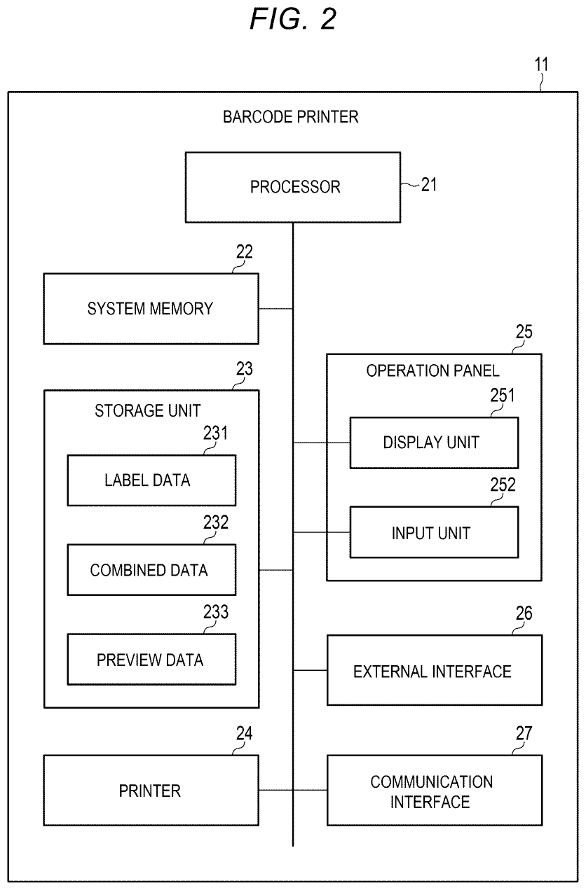

FIG. 2 is a block diagram showing a configuration example of a control system in the barcode printer 11 of the label printing system 1 according to the embodiment.

The barcode printer 11 includes a processor 21, a system memory 22, a storage unit 23, a printer 24, the operation panel 25, an external interface 26, a communication interface 27, and the like.

The processor 21 provides control of the units, information processing, and the like. The processor 21 is, for example, a CPU. The processor 21 executes the program stored in the system memory 22 or the storage unit 23. The processor 21 outputs an operation instruction to the units or processes various types of information provided from the units by executing the program.

The system memory 22 includes memories such as a random access memory (RAM), a read only memory (ROM), and an NVM (non-volatile memory). The RAM functions as a working memory or a buffer memory. The ROM is a non-rewritable nonvolatile memory. The ROM functions as a program memory. The NVM is a rewritable nonvolatile memory. The NVM stores a program, control data, data such as setting information, and the like.

The storage unit 23 can be implemented as a rewritable nonvolatile memory. For example, the storage unit 23 can be a storage device such as a hard disk drive (HDD) or a solid-state drive (SSD). The storage unit 23 stores, for example, image data. The storage unit 23 may store a program, control data, and data such as setting information.

The storage unit 23 of the barcode printer 11 includes a storage region 231, a storage region 232, and a storage region 233.

The storage region 231 stores, for example, label data in the state (the initial state) in which data is not input to the variable data region. When the stand-alone printing is performed, label data to be printed is selected from the label data stored in the storage region 231.

The storage region 232 stores label data (combined data) in the state in which data is embedded (combined) in the variable data region.

The storage region 233 stores display data of a preview image as a print image to be printed based on the label data. As preview data, the storage region 233 may store image data of the preview image itself or may store information indicating a storage destination for the preview image.

The printer 24 prints an image on a medium that can be used as a label. The printer 24 prints the image of the label for a predetermined width (a label width). The printer 24 prints the image on the label medium based on label data. The printer 24 is not limited to a specific image forming method, and may form an image on the medium using any available image forming or printing method.

The operation panel 25 includes a display unit (a display device) 251 and an operation unit (an operation device) 252. The display unit 251 is implemented by a display device such as a liquid crystal display. The display content of the display unit 251 is controlled according to an operation instruction from the processor 21. The operation unit 252 is implemented by a touch panel, an operation button, or the like. For example, the display unit 251 and the operation unit 252 are implemented by a display device with a touch panel. For example, the processor 21 displays an icon that can be selected on the touch panel serving as the operation unit 252 on the display screen of the display unit 251 together with the operation guidance. Accordingly, the processor 21 acquires input data according to the touch position detected by the touch panel.

The external interface 26 is an interface for connecting the external input device 12. The external interface 26 may be connected to the external input device 12 by wire, or may be connected to the external input device 12 wirelessly. The external interface 26 may include a plurality of types of interfaces corresponding to various external input devices 12.

The communication interface 27 is an interface for communicating with an external device. For example, the communication interface 27 includes an interface for communicating with the smart device 13. The communication interface 27 also includes an interface for communicating with the cloud server 14. The communication interface 27 may be one that communicates by wire or may be one that communicates wirelessly.

Next, the label data for printing the label by the barcode printer 11 in the label printing system 1 according to an embodiment will be described.

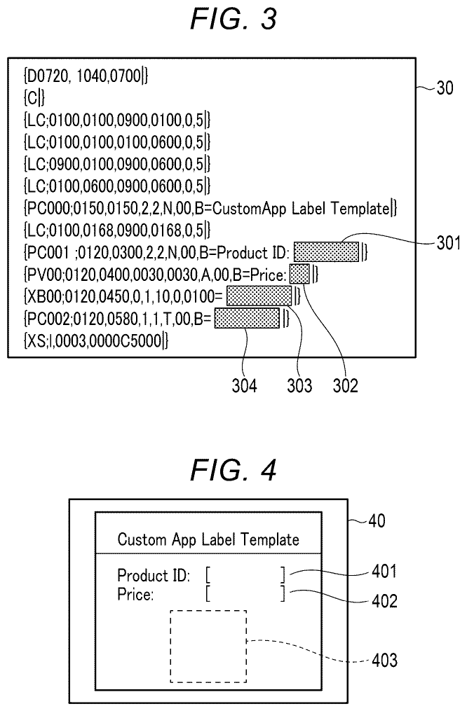

FIGS. 3 and 4 are diagrams showing the label data before variable data is combined with fixed data.

FIG. 3 is a diagram showing an example of the label data as printer description language (PDL) for a print command or the like.

In the label data shown in FIG. 3, regions (variable data regions) 301, 302, 303, and 304 are set for variable data to be input in a data string (a data string format) including the fixed data. The label data shown in FIG. 3 is label data in an initial state before the variable data is embedded or otherwise incorporated. The storage region 231 stores the label data in an initial state (label data before without specific variable data being included therein) as shown in FIG. 3.

The variable data regions 301 to 304 may be set to receive information/data from a particular external input device (for example, the code reader 121, the keyboard 123, or the like). For example, the variable data region 301 is defined such that data serving as a product ID will be input by the code reader 121. The variable data region 302 is defined such that data serving as a price will also be input by the code reader 121. The variable data regions 303 and 304 in this example are also defined such that data will be input by the code reader 121.

FIG. 4 is a diagram showing a print image corresponding to the label data shown in FIG. 3.

Since no data has been stored in the variable data regions 301 to 304. Therefore, in the print image shown in FIG. 4, image regions 401, 402, 403 corresponding to the variable data regions 301 to 304 are left blank.

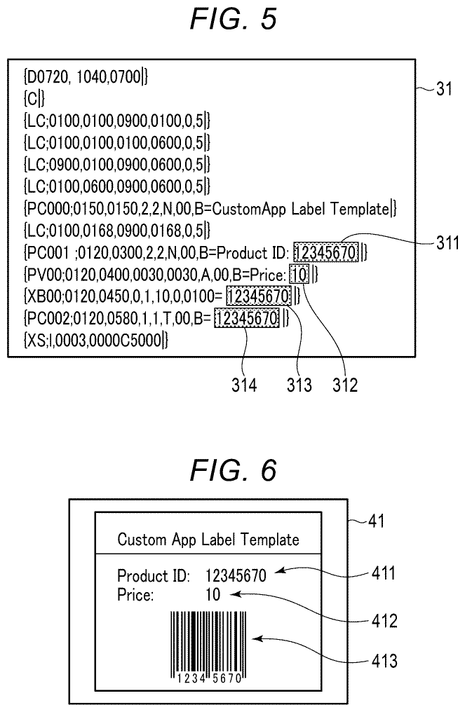

FIGS. 5 and 6 are diagrams showing label data after the variable data is combined with the fixed data.

FIG. 5 is a diagram showing the label data after the variable data has been included in the variable data regions 301 to 304.

The label data shown in FIG. 5 is an example of the label data after the variable data is embedded in the variable data regions. The label data in this state may be referred to as the combined data. The storage region 232 of the storage unit 23 stores the label data (the combined data) as shown in FIG. 5.

The data acquired from an external input device 12 can be set for each of the variable data regions. For example, the code reader 121 (serving as an external input device 12) is associated with the variable data regions 301 to 304. In this case, data read by the code reader 121 is embedded in the variable data regions 301 to 304 as appropriate. Specifically, in the example shown in FIG. 5, “12345670” as read by the code reader 121 is embedded as a product ID in the variable data region 301. In the variable data region 302, a value “10” is embedded as a price when read by the code reader 121.

FIG. 6 is a diagram showing a print image after the label data is embedded in the variable data regions as shown in FIG. 5.

The label data shown in FIG. 5 is in the state in which the data has been stored in the variable data regions 311 to 314 along with the fixed data. Therefore, in the print image of the label data shown in FIG. 6, an image is displayed in the image regions 411 to 413 corresponding to the variable data regions 311 to 314. The data in the variable data regions 311 and 312 is now displayed in the image regions 411 and 412. The data in the variable data regions 313 and 314 is now displayed as a barcode image in the image region 413.

Next, a user interface provided to the operator for performing the stand-alone printing using the barcode printer 11 will be described.

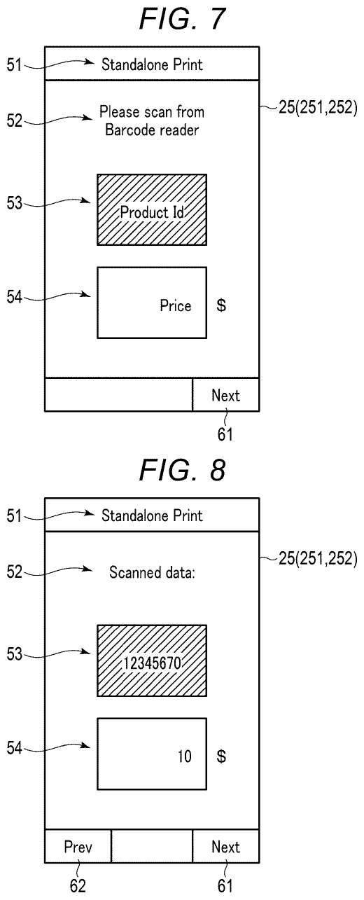

FIGS. 7 to 9 show an example of the display screens (and transitions therebetween) displayed on the operation panel 25 during the stand-alone printing process.

When stand-alone printing is to be performed with the barcode printer 11, the operator selects the stand-alone printing option or mode using the operation unit 252 of the operation panel 25. The operator then designates (selects) the label data to be printed in the stand-alone printing. For example, the barcode printer 11 stores various label data formats or types that can be printed in the storage region 231 of the storage unit 23.

The processor 21 reads the label data selected by the operator from the storage region 231. The processor 21 displays on the display unit 251 a guidance screen that prompts the operator to input data using an external input device 12 set as corresponding to a variable data region in the selected label data. For example, the guidance screen suggests the operator use the code reader 121 to provide data for a variable region. The guidance screen may be referred to as a data reading screen.

FIG. 7 is a diagram showing a display example of a data reading (input) screen (a guidance screen) displayed on the display unit 251 of the barcode printer 11.

In the display example shown in FIG. 7, the display unit 251 displays guidance that prompts use of the code reader 121 to read a barcode or barcodes corresponding to the product ID and the price. In the display example shown in FIG. 7, a display region 51 displays the guidance indicating that stand-alone printing is being performed. A display region 52 displays the guidance that prompts the operator to use the code reader 121 to read the required data. A display region 53 displays a display field for the product ID. A display region 54 displays a display field for the price.

The operator uses the code reader 121 connected to the barcode printer 11 to scan a barcode indicating the product ID and the price for the product to which the label will be placed on. The code reader 121 supplies data indicating the read product ID and corresponding price to the barcode printer 11.

The barcode printer 11 acquires this data indicating the product ID and price from the code reader 121 through the external interface 26. The processor 21 of the barcode printer 11 then displays, on the display unit 251, a reading result screen that now displays the product ID and price that was acquired from the code reader 121 (or other input). After acquiring the data from the code reader 121, the processor 21 may transition to a data reading result screen in response to a pressing of a next button 61 or the like.

FIG. 8 is a diagram showing a display example of the data reading result screen as displayed on the display unit 251 of the operation panel 25 of the barcode printer 11.

In the display example in FIG. 8, the display unit 251 displays the product ID and the price read by the code reader 121 or otherwise input. The display region 52 displays the guidance indicating that the data was read (“scanned”) by the code reader 121. The display region 53 now displays the actual product ID as read by the code reader 121. The display region 54 now displays the product price as read by the code reader 121.

In FIG. 8, the operation unit 252 can accept the pressing of the next button 61 for transitioning to the next screen or a prev button 62. In some examples, the next button 61 and the prev button 62 may be implemented as hard keys or may otherwise be selectable by using the touch panel.

If the operator is not satisfied with the data now displayed on the display unit 251 as the data reading result screen, the operator can press the prev button 62. When the prev button 62 is pressed, the processor 21 returns to the data reading screen as shown in FIG. 7, and accepts other or additional data input by the code reader 121 or otherwise. If the operator is satisfied with the data displayed on the display unit 251 as the data reading result screen, the operator presses the next button 61. When the next button 61 is pressed (when the data input is completed), the processor 21 causes the display unit 251 to transition to a preview link screen that displays access information for the preview image. The access information may indicate a link destination or the like for accessing the preview image.

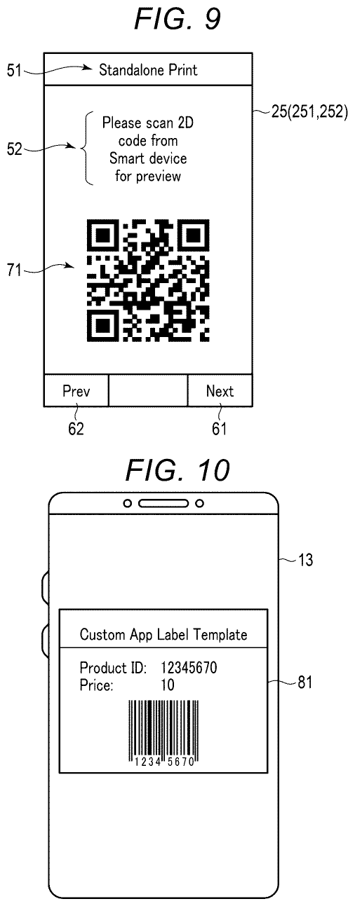

FIG. 9 is a diagram showing a display example of a preview link screen that can be displayed on the display unit 251 of the operation panel 25 of the barcode printer 11.

In the display example shown in FIG. 9, the display unit 251 displays a code image 71 (a two-dimensional code) encoding or otherwise providing the access information for accessing the preview image. The code image 71 may be referred to as a preview image link or the like. When the input of the data for the variable data regions is completed, the processor 21 of the barcode printer 11 generates the combined label data obtained by combining the input data with empty label data. When the combined label data is generated, the processor 21 generates a preview image depicting a print image based on the combined label data.

The processor 21 stores the generated preview image in a storage destination (a link destination) so that it can be accessed from a smart device 13. In general, processor 21 generates the two-dimensional code by encoding the access information corresponding to the storage destination for the preview image. The processor 21 displays, on the display unit 251, the preview link screen (see FIG. 9) including the two-dimensional code obtained by encoding the access information for the preview image.

The operator may then cause the smart device 13 to read the two-dimensional code being displayed on the display unit 251. For example, the smart device 13 activates an application program (a two-dimensional code reading application) for reading the two-dimensional code, and captures an image of the two-dimensional code using the camera 132. The smart device 13 decodes the two-dimensional code that was captured by the camera 132, and accesses the storage destination of the preview image based on the access information encoded in the two-dimensional code. The smart device 13 then displays the preview image from the storage destination indicated by the two-dimensional code on the display device 131 or the like.

FIG. 10 shows an example in which the smart device 13 displays a preview image 81 that was acquired from the storage destination as indicated by the access information of the two-dimensional code.

Here, it is assumed that the smart device 13 displays the preview image 81 on the display device 131 that has a touch panel integrated therewith. The smart device 13 can not only display the preview image 81 on the display device 131, but also allow for changes in the display state of the preview image 81 in response to the operations of the operator. For example, the smart device 13 can enlarge or reduce the preview image 81 in response to a pinch-in or pinch-out operation detected on the touch panel. Accordingly, the operator can check the preview image 81 displayed on the display device 131 of the smart device 13 in detail.

After checking the preview image 81 on the smart device 13, the operator can select or instruct whether to print the preview image 81. For example, on the screen shown in FIG. 9, the operator presses the next button 61 to print the preview image 81 or presses the prev button 62 to cancel printing. The processor 21 of the barcode printer 11 performs printing based on the label data indicated i by the preview image 81 when instructed to perform printing, and stops printing (generation of the label data) when instructed to cancel printing. Accordingly, the operator can instruct execution or cancellation of printing after checking the preview image 81 by using the smart device 13.

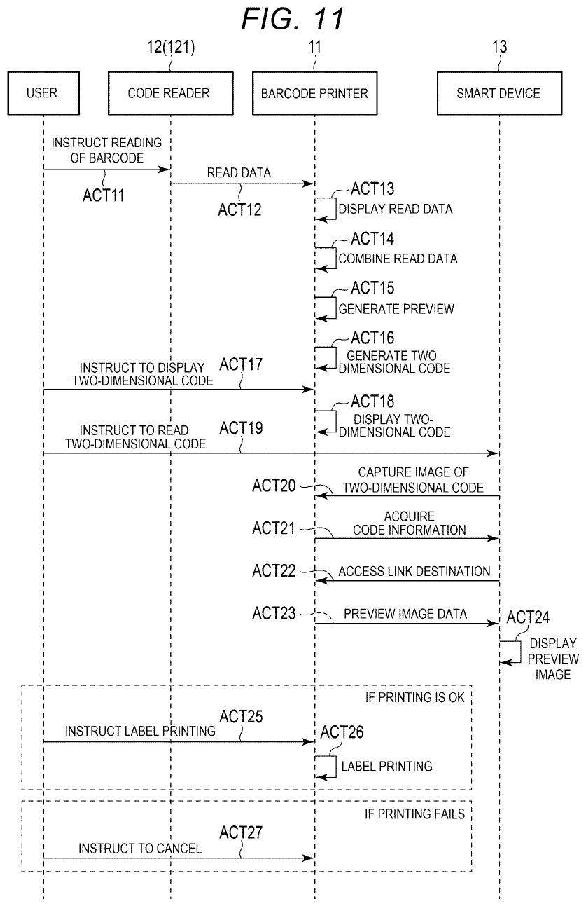

FIG. 11 is a sequence diagram showing an operation example of a printing system 1 including a barcode printer 11, a code reader 121, and a smart device 13 according to an embodiment.

First, it is assumed that the operator (the user) designates the label data to be printed in the stand-alone printing operation by using the operation unit 252 of the barcode printer 11. The processor 21 reads the initial (blank) label data as designated from the label data in the storage region 231.

The processor 21 of the barcode printer 11 displays, on the display unit 251, the guidance screen (for example, the data reading screen shown in FIG. 7) prompts the user to acquire or input the data for the variable data regions of the designated label data. Here, it is assumed in this example that the processor 21 prompts the user to use the code reader 121 as an external input device 12 to acquire the data to be input into a variable data region.

In this example, the user performs (instructs) the reading of a barcode indicating the data to be placed in the variable data by using the code reader 121 as an external input device 12 (ACT 11). The code reader 121 reads the barcode indicating the data to be used for the variable data. The code reader 121 supplies the data (the read data for the variable regions) to the barcode printer 11 (ACT 12).

The barcode printer 11 acquires the read data (the data to be embedded in a variable data region) from the code reader 121 through the external interface 26. After the processor 21 of the barcode printer 11 acquires input from the code reader 121, the processor 21 displays the data reading (input) result screen indicating the just acquired read data on the display unit 251 (ACT 13). For example, the processor 21 displays a screen as shown in FIG. 8 on the display unit 251 as a data reading result screen.

When the processor 21 acquires the data to be embedded in the variable data region and generates the combined label data (ACT 14). The processor 21 stores the combined label data in the storage region 232 of the storage unit 23.

Next, the processor 21 generates a preview image for a print image based on the combined label data (ACT 15). The processor 21 also stores the generated preview image in a storage destination that can be accessed from the smart device 13.

The processor 21 of the barcode printer 11 generates a two-dimensional code by encoding the access information that indicates the storage destination (the link destination) of the preview image (ACT 16). The processor 21 may then accept a request to display the two-dimensional code on the display unit 251.

The user can then check the data reading result screen displayed on the display unit 251 of the barcode printer 11. The user can use the operation unit 252 to request a display of the two-dimensional code providing the access information to the preview image (ACT 17). For example, the user requests the display of the two-dimensional code by pressing the next button 61 on the data reading result screen shown in FIG. 8.

When the request to display the two-dimensional code is instructed, the processor 21 of the barcode printer 11 displays the two-dimensional code on the display unit 251 (ACT 18). For example, the processor 21 displays, on the display unit 251, the preview link screen shown in FIG. 9.

After the two-dimensional code is displayed on the display unit 251 of the barcode printer 11, the user performs an operation for causing a smart device 13 to read the two-dimensional code (ACT 19). For example, the user activates an application for reading a two-dimensional code in the smart device 13. When the application for reading the two-dimensional code is activated, the user performs an operation for capturing an image of the two-dimensional code using the camera 132 of the smart device 13.

The smart device 13 captures, using the camera 132, an image of the two-dimensional code displayed on the display unit 251 in response to the operation of the user (ACT 20). The smart device 13 acquires the access information by decoding the two-dimensional code by decoding the two-dimensional code in the image captured by the camera 132 (ACT 21).

After smart the device 13 acquires the access information corresponding to the two-dimensional code, the smart device 13 accesses the preview image at the link destination indicated (ACT 22). After the smart device 13 accesses the link destination indicated by the access information, the smart device 13 acquires the preview image (ACT 23). The smart device 13 then displays the preview image on the display device 131 (ACT 24). For example, as shown in FIG. 10, the smart device 13 displays the preview image on the display device 131. The smart device 13 can display the preview image on the display device 131 and permit changes to the state of the displayed preview image according to the operation(s) of the user.

The user checks the preview image on the display device 131 of the smart device 13, and then selects and instructs whether to perform or cancel printing. For example, while the preview link screen shown in FIG. 9 is being displayed, the user presses the next button 61 to perform printing or the prev button 62 to cancel printing.

When instructed to perform printing (ACT 25), the processor 21 of the barcode printer 11 creates a label by performing a printing based on the combined label data shown in the preview image (ACT 26). When instructed to cancel printing by the operation unit 252 (ACT 27), the processor 21 of the barcode printer 11 cancels the printing of the generated combined label data.

According to a printing system 1, as described above, the user can check a preview image in detail using the smart device 13 when performing a stand-alone printing using a barcode printer 11. The user can then decide whether to instruct or cancel a printing after viewing the print image (preview image) on the smart device 13. The clearer and potentially more detailed review available via use of the smart device 13 can prevent misprints and/or printing of a label different from the intention of the user.

Next, the operation of the barcode printer 11 according to an embodiment will be described.

In the following description, aspects of the operation of the barcode printer 11 in a printing system 1 that operates as shown in FIG. 11 is primarily described.

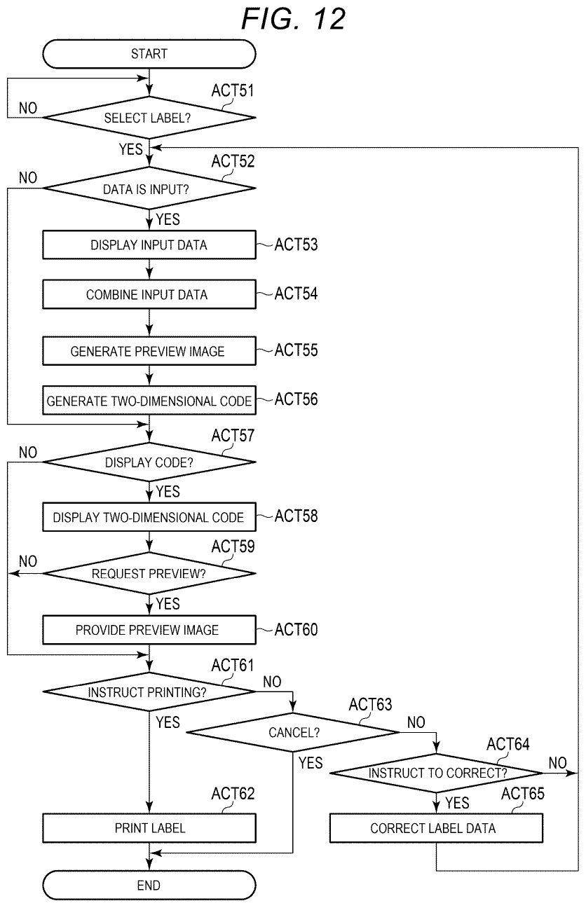

FIG. 12 is a flowchart showing an operation example of the barcode printer 11 according to an embodiment.

The processor 21 of the barcode printer 11 waits for selection of the label data to be printed in the stand-alone printing by the user using the operation unit 252 (ACT 51).

The processor 21 reads the label data in the selected label data (e.g., empty or blank label data to be filled in with variable data) from the storage region 231. The processor 21 displays, on the display unit 251, a guidance screen (for example, the data reading screen shown in FIG. 7) that prompts the user to acquire the data for the variable data regions of the selected label data. The processor 21 accepts the input of the data from an external input device 12 (ACT 52).

When the data input is received from an external input device 12 connected to the external interface 26 (YES in ACT 52), to be embedded in a variable data region. The processor 21 displays, on the display unit 251, a screen (e.g., a data input result screen) showing the data acquired from the external input device 12 for a variable data region (ACT 53).

The processor 21 generates the combined label data by embedding (combining) the data acquired from the external input device 12 into the variable data region(s) of the selected blank label data (ACT 54). The processor 21 stores the combined label data in the storage region 232 of the storage unit 23.

When the combined label data is generated, the processor 21 generates a preview image based on the generated combined label data (ACT 55). The processor 21 stores the generated preview image in a storage destination that can be accessed from the smart device 13. The processor 21 may store the preview image in the storage unit 23 in the barcode printer 11 or in the cloud server 14.

After the preview image is stored, the processor 21 generates the access information indicating the storage destination (the link destination) in which the preview image is stored. Here, it is assumed that the processor 21 provides the access information to the smart device 13 in the form of a visual two-dimensional code. In this case, the processor 21 generates the two-dimensional code obtained by encoding the access information indicating the link destination for the preview image (ACT 56).

After generating the two-dimensional code, the processor 21 can accept the instruction to display the access information (the two-dimensional code) for the preview image from an operation on the operation unit 252 (ACT 57). For example, the processor 21 accepts this instruction via the pressing of the next button 61 then displays the two-dimensional code on the data reading result screen such as shown in FIG. 8.

Once instructed to display the two-dimensional code, the processor 21 displays the two-dimensional code on the display unit 251 (ACT 58). For example, the processor 21 displays the two-dimensional code on the preview link screen shown in FIG. 9 on the display unit 251.

After the two-dimensional code is displayed on the display unit 251, the processor 21 can accept a request to provide the preview image by accessing of the link destination by the two-dimensional code (ACT 59). It is assumed display of the preview image is requested by accessing the link destination indicated by the two-dimensional code via the smart device 13. After the link destination is accessed (YES in ACT 59), the processor 21 provides the preview image (ACT 60).

That is, the processor 21 provides the preview image to the smart device 13 that accesses the link destination indicated by the two-dimensional code. For example, the processor 21 provides the preview image to the smart device 13 as display data that can be displayed by a web browser. Accordingly, the barcode printer 11 can provide the preview image after the variable data combination with the label data for review on the smart device 13. In some examples, the processor 21 may transmit the display data for the preview image to the smart device 13 by a short-range wireless communication or the like.

When the preview image is stored in cloud server 14, the cloud server 14 may provide the preview image to the smart device 13. For example, the cloud server 14 stores the preview image supplied from the barcode printer 11 and accepts the request to display the preview image. In this case, for example, the cloud server 14 may provide, to the smart device 13, the preview image as designated by a URL corresponding to a dedicated website or the like.

The processor 21 of the barcode printer 11 may then accept an instruction (the print instruction) to perform label printing, a cancellation of label printing, or an instruction to correct the label data (ACTS 61, 63, and 64). When instructed to perform label printing (YES in ACT 61), the processor 21 performs printing based on the combined label data (ACT 62).

When instructed to cancel label printing (YES in ACT 63), the processor 21 discards the combined label data and ends the processing. For example, the processor 21 may return to ACT 51 when instructed to cancel a label printing and may accept another selection of label data.

When instructed to correct the combined label data (YES in ACT 64), the processor 21 executes data correction on the combined label data as appropriate (ACT 65). For example, the processor 21 may accept the correction to the label data via the website that displays the preview image. In this case, the processor 21 corrects the label data according to instructions or changes made by the user on the preview image using the touch panel or the like of the smart device 13.

Specifically, the processor 21 may make changes to the preview image such as moving, enlarging, reducing sub-regions of the preview image using the touch panel of the smart device 13. After the user instructs the processor 21 to reflect the changed preview image, the processor 21 can correct the label data to be printed according to the changed preview image. The processor 21 may also accept changes or the like from an external input device for input to a specific variable data region in the preview image displayed on the website.

After accepting the correction of the combined label data in this manner, the processor 21 corrects the combined label data for the label being created according to the instructions of the user. After the combined label data is corrected, adjusted, updated or the like, the processor 21 stores the corrected label data in the storage region 232 of the storage unit 23 and returns to ACT 52.

As described above, a barcode printer 11 serving as an image forming apparatus according to an embodiment receives the data to be combined with the fixed data stored in the memory from an external input device 12 or the like. The barcode printer 11 generates a preview image indicating the image to be printed by the barcode printer 11. The barcode printer 11 can display the information on its display device or the like to permit the accessing of the preview image on another display device.

Accordingly, a user can acquire the access information from the barcode printer 11 using a smart device 13 and can display a preview image on the smart device 13. As a result, the user can check the image to be printed based on the combined data in better detail using the smart device 13 or the like before performing a printing.

While certain embodiments have been described, these embodiments have been presented by way of example only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. An image forming apparatus, comprising:
a printer unit configured to print images;
a display screen for displaying information to an operator;
an operation panel for permitting the operator to select an image template for printing, the image template including a fixed data region and a variable data region;
an external interface configured to connect to an external input device to receive input data to be included in the variable data region of a selected image template; and
a processor configured to:
generate a preview image of an image to be printed by the printer unit, the preview image corresponding to the selected image template with the received input data included in the variable data region,
store the preview image in a storage location accessible by an external device,
generate a code image indicating the storage location, and
display the code image on the display screen upon a request of the operator.

2. The image forming apparatus according to claim 1, wherein the display screen is integrated with the operation panel.

3. The image forming apparatus according to claim 1, wherein the external input device is directly connected to the external interface.

4. The image forming apparatus according to claim 3, wherein the external input device is a code reader.

5. The image forming apparatus according to claim 3, wherein the external input device is a weight scale.

6. The image forming apparatus according to claim 3, wherein the external input device is a thermometer.

7. The image forming apparatus according to claim 1, further comprising:
a communication interface configured to wirelessly communicate with the external device.

8. The image forming apparatus according to claim 1, further comprising:
a storage unit, wherein
the storage unit stores a plurality of image templates.

9. The image forming apparatus according to claim 8, wherein the storage location for the preview image is in the storage unit.

10. The image forming apparatus according to claim 1, further comprising:
a communication interface configured to connect to an external server, wherein
the storage location for the preview image is in the external server.

11. A barcode printer, comprising:
a printer unit configured to print images on label stock;
a touch panel display screen for displaying information to an operator and for permitting the operator to select a label template for printing, the label template including a fixed data region and a variable data region;
an external interface connected to an external input device to receive input data to be included in the variable data region of a selected label template; and
a processor configured to:
generate a preview image of an image to be printed on a label by the printer unit, the preview image corresponding to the selected image template with the received input data included in the variable data region,
store the preview image in a storage location accessible by an external smart device,
generate a code image indicating the storage location, and
display the code image on the touch panel display screen upon a request of the operator.

12. The barcode printer according to claim 11, wherein the external input device is a code reader.

13. The barcode printer according to claim 11, wherein the external input device is a weight scale.

14. The barcode printer according to claim 11, wherein the external input device is a thermometer.

15. The barcode printer according to claim 11, further comprising:
a communication interface configured to wirelessly communicate with the external smart device.

16. The barcode printer according to claim 11, further comprising:
a storage unit, wherein
the storage unit stores a plurality of label templates.

17. The barcode printer according to claim 16, wherein the storage location for the preview image is in the storage unit.

18. The barcode printer according to claim 11, further comprising:
a communication interface configured to connect to an external server, wherein
the storage location for the preview image is in the external server.

19. A label printing system, comprising:
a smart device of an operator; and
an image forming apparatus including:
a printer unit configured to print images;
a display screen for displaying information to the operator;
an operation panel for permitting the operator to select an image template for printing, the image template including a fixed data region and a variable data region;
an external interface configured to connect to an external input device to receive input data to be included in the variable data region of a selected image template; and
a processor configured to:
generate a preview image of an image to be printed by the printer unit, the preview image corresponding to the selected image template with the received input data included in the variable data region,
store the preview image in a storage location accessible by the smart device,
generate a code image indicating the storage location, and
display the code image on the display screen upon a request of the operator.

20. The label printing system according to claim 19, further comprising:
an external server connectable to the image forming apparatus and the smart device, wherein
the storage location is in the external server.
